(19) United States
(12) Patent Application Publication
(10) Pub. No.: US 2002/0069579 A1
(43) Pub. Date: Jun. 13, 2002

(54) Liquid bait station with internal wicking action

(75) Inventors: Stephanie H. Hyatt, Stockbridge, GA (US); Lisa Blum, Concord, CA (US)

Correspondence Address: Joel J. Hayashida,, Corporate Patent Counsel, The Clorox Company, P. O. Box 24305, Oakland, CA, 94623, US

(73) Assignee: The Clorox Company, a Delaware Corporation, Oakland, CA

(21) Appl. No.: 10/000,434

(22) Filed: Nov. 30, 2001

Related U.S. Application Data
(63) Continuation of application No. 08/986,073, filed on Dec. 5, 1997, now abandoned.
Application No. 08/986,073 is a continuation-in-part of application No. 08/768,006, filed on Dec. 13, 1996, now abandoned.

(51) Int. Cl. A01M 1/20; A01M 25/00

(52) U.S. Cl. 43/131

(57) ABSTRACT

An insect bait station for providing liquid bait to targeted insects providing a bait station including a reservoir and cover joined in liquid-tight relation having access ports in the cover providing a target insect entering the cover feeding chamber access to liquid insect bait to a wicking material interposed between the liquid reservoir and feeding chamber in the bait station. Spill-resistant access means provides a target insect located in the feeding chamber of the bait station cap access to liquid insect bait confined within the feeding chamber safely inaccessible by children, animals, birds and the like.

This application is a continuation-in-part of U.S. Ser. No. 08/768,006, filed Dec. 13, 1996.

The present invention relates generally to the field of insect bait stations. More particularly, the invention relates to insect bait stations adapted to contain a liquid insect bait.

The present invention relates to a poison liquid container which will dispense the liquid so that insects may feed thereon and has as its principle object to provide a structure which prevents the toxic liquid from becoming spilled, even when the container is upset or in any other manner disturbed. It is customary in controlling insects to place the poison liquid receptacles or dispensing devices in areas which from time to time may be visited by children, animals or birds. With the present improved structure, access to the toxic liquid is avoided.

### BACKGROUND OF THE INVENTION

The art is generally aware of insect bait for feeding stations having a base joined to a cover that extends over the base to produce a hollow body. Woodruff et al., U.S. Pat. No. 4,563,836 and Brandli, U.S. Pat. No. 5,048,225 are examples of such insect feeding stations that are intended to contain a poisoned solid bait, with much of the structure of the insect feeding station intended to restrict access to the poisoned bait by a user, pet, or the like. Mullen et al., U.S. Pat. No. 5,090,153 is of similar structure but uses food or a pheromone to lure insects, which then are trapped in a sticky material applied to the central portion of the base.

Generally similar traps or feeding stations are disclosed in Rhodes, U.S. Pat. No. 5,152,097; Warner, U.S. Pat. No. 5,231,792; Tippey, U.S. Pat. No. 1,856,200; Gentile, U.S. Pat. No. 4,793,093; Harroun, U.S. Pat. No. 2,123,995; and Howard, U.S. Pat. No. 884,928.

A number of devices are known in the art that are specifically adapted to contain insect baits or poisons in liquid form. For example, Demarest et al., U.S. Pat. No. 5,033,229, provides an absorbent mat that serves as the floor of a circular structure. Insects gain access to the floor by crawling through ports located in the side of the structure. A reservoir above the circular mat is adapted to allow a liquid bait to seep down onto the mat and soak into it. Schlesinger, U.S. Pat. No. 1,573,278, includes a central well for holding a liquid insect poison and a hollow, cylindrical wick that lines and extends upwardly from the sides of the well to a cover. Liquid can soak through the wick to wet a fringe that surrounds the wick and is exposed to feeding ants. The wick is closed by the cover, which also extends over the rest of the bait station. The wick, together with the cover, is intended to prevent spillage of the liquid poison, should the device be turned on its side. The cover, together with a base, provides an enclosed feeding chamber surrounding the well and its cylindrical wick. Although this and other prior art incorporate the use of a wick to prevent spillage of a liquid bait, it is additionally an object of this invention to prevent access to the wick by children.

An ongoing need still exists in the art for an economical and easily manufactured insect bait station that can contain a liquid insect bait in such a way as to minimize the chance of spillage and access by children while, at the same time, providing for access to that bait by targeted insects. Liquid insect baits offer various advantages with respect to ants, wasps, cockroaches, and other insects that can easily assimilate food when it is in a liquid or liquifiable form.

### SUMMARY OF THE INVENTION

The present invention is summarized in that an insect bait station for offering a liquid insect bait to targeted insects is provided which will dispense the liquid through a wicking material so that insects may feed thereon and has as its principle object to provide a structure which will prevent the poison liquid from becoming spilled, even though the container is upset or in any other manner disturbed. A further objective of this invention is to prevent access by children to the poison liquid or the wicking material. The insect bait station of the present invention includes a hollow body having a base and a cover, the cover being joined to the base in a liquid tight relation, the hollow body consisting of a reservoir, the cover consisting of a wicking material, and having exterior openings to provide access by the target insects to the wicking material. The bait station is a substantially elongated configuration and lies in a longitudinal or horizontal mode when placed in the habitat of a target insect. The bait station is designed to hold a reservoir of liquid that is in contact with the interior wick material where the wicking material is attached to the end cap or cover for the station or said material is inserted into the reservoir and held in place with the end cap or cover. The end cap contains insect access ports with the wicking material spatially placed inward away from said access ports. The cover provides a tight seal so that the liquid is in contact only with the wicking material and minimizes evaporation when in use. The station can be designed to hold various amounts of liquid and can be of any particular shape, preferably having an elongated configuration.

Whereas wicking action has been known in the prior art, the cap and wick arrangement of the present invention provides that insects will have access to the wick providing liquid thereto by limiting direct access to the liquid and the wick by children, animals, birds, and the like. Therefore the preferred spill resistant access means includes a capillary liquid transport means for transporting the liquid insect bait from the reservoir to the wicking material surface that is accessible to the targeted insects after the insect enters the interior feeding chamber of the bait station.

### BRIEF DESCRIPTION OF THE DRAWINGS

Many advantages of the present invention will be apparent to those of ordinary skill in the art when this specification is read in conjunction with the attached drawings. The invention will now be described with reference to the accompanying drawings wherein like reference numerals are applied to like elements and wherein:

FIG. 1 is a pictorial perspective partially broken away of an embodiment of the present invention.

FIG. 2 is an exploded perspective of the embodiment of the present invention as shown in FIG. 1.

FIG. 3 is a half section taken along lines 3-3 of FIG. 1.

FIG. 4 is a pictorial perspective partially broken away of an embodiment of the present invention.

FIG. 5 is an exploded perspective of the embodiment of the present invention as shown in FIG. 4.

FIG. 6 is a full section view taken along lines 6-6 of FIG. 4.

FIG. 7 is a pictorial perspective partially broken away of an embodiment of the present invention.

FIG. 8 is an exploded perspective of the embodiment of the present invention as shown in FIG. 7.

FIG. 9 is a full sectional view taken along lines 9-9 of FIG. 7.

FIG. 10 is a pictorial perspective partially broken away of an embodiment of the present invention.

FIG. 11 is an exploded perspective of the embodiment of the present invention as shown in FIG. 10.

FIG. 12 is a full sectional view taken along lines 12-12 of FIG. 10.

FIG. 13 is a pictorial perspective partially broken away of an embodiment of the present invention.

FIG. 14 is an exploded perspective of the embodiment of the present invention as shown in FIG. 13.

FIG. 15 is a full sectional view taken along lines 15-15 of FIG. 13.

FIG. 16 is an exploded perspective of another embodiment of the present invention.

### DETAILED DESCRIPTION OF THE PREFERRED EMBODIMENT

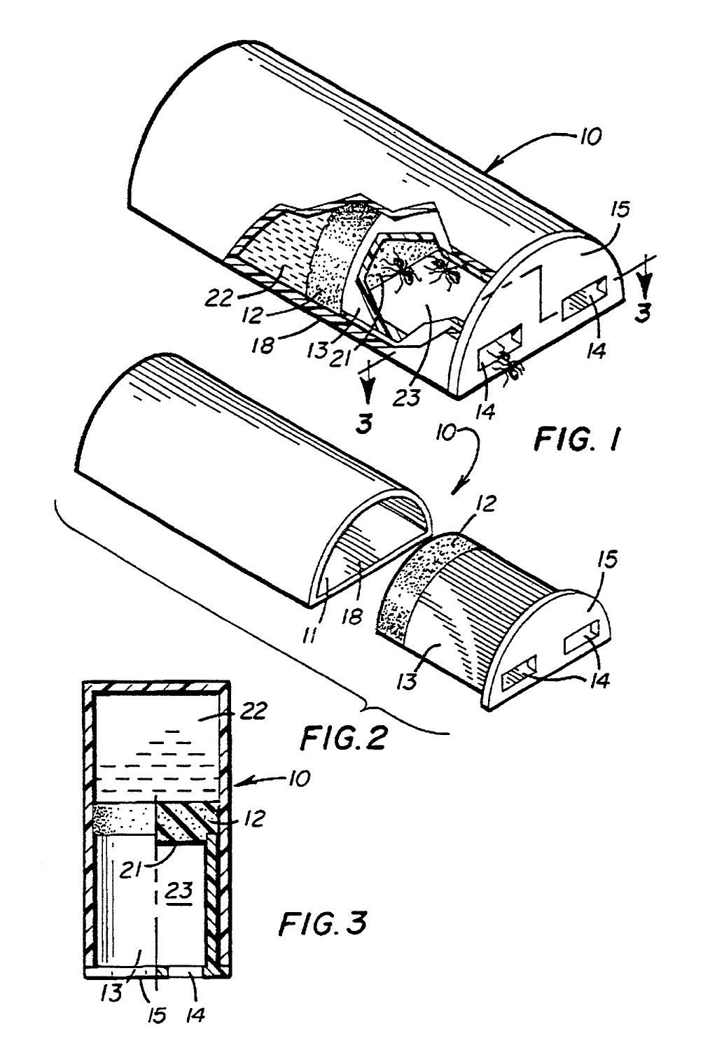

With reference to the drawings, wherein like parts are indicated by like reference numbers, a first and preferred embodiment of the insect bait station of this invention is shown generally in FIG. 1 at 10. The bait station has a base 11 and an end cap 13. The end cap 13 is joined to the base 11 in a liquid-tight relation to form a hollow body reservoir 20.

The base 11 has a floor 18. The end cap 13 has an interior feeding chamber 23 and terminal portion of wicking material 12. As can be seen in the exploded view FIG. 2, reservoir 20 is engaged with the cap 13 such that the wicking material placed into the reservoir 20 and the remainder of the cap 13 defines a reservoir chamber 22 wherein liquid insect bait may be confined.

The insect bait station 10 of this invention also has spill-resistant access means for providing a targeted insect located in the feeding chamber 23, access to liquid insect bait confined within the feeding chamber 23. Preferably the spill-resistant access means includes capillary liquid transport means for transporting the liquid insect bait from the reservoir 20 of the base 11 to a location in the feeding chamber 23 where it is accessible to a targeted insect. In the embodiment of the insect bait station of the invention shown at FIGS. 1-6, entry ports 14 are provided which extend through the cap cover front 15 to communicate with the interior of the feeding chamber 23. The access ports 14 are of a size such that at least the feeding structures of targeted insects may reach through the access ports and into the feeding chamber 23. Preferably the wicking material feeding surface 21 is spaced away and interior from the cap front. This design is preferred since the cap and wicking material arrangement provides insects access to the feeding side of the wick 21 but is spaced away interiorly from the cap cover 15 to prevent children or animals from accessing the feeding portion of the wick through the insect entry ports 14. Preferably, the cap 13 is capable of being pushed inside the bait station to be flush with the front edge 19 and locked therein, so that it cannot be pulled out.

The access ports 14 can be modified in size for different insects, such as ants and roaches. For ant entry, the holes can be small. For roach entry, the holes would necessarily be larger, could still have short entrance height that would be small enough to limit access to the surface 21 of the wicking material 12 by children.

Preferably, the entry ports 14 are only sufficiently large that targeted insects may pass through the entry ports and actually enter the feeding chamber 23, while small enough to prevent access by others such as children and pets. Within the feeding chamber 23, the insects may then access the feeding surface 21 of the wicking material 12. When a liquid insect bait used with the bait station 10 includes an insecticide, it is preferred that the insecticide be of a slow killing nature of the sort well known in the art, so that a feeding insect may leave the insect bait station and return to its nest or hive to redistribute the poisoned bait among insects congregated there and substantially to die at a location remote from the insect bait station.

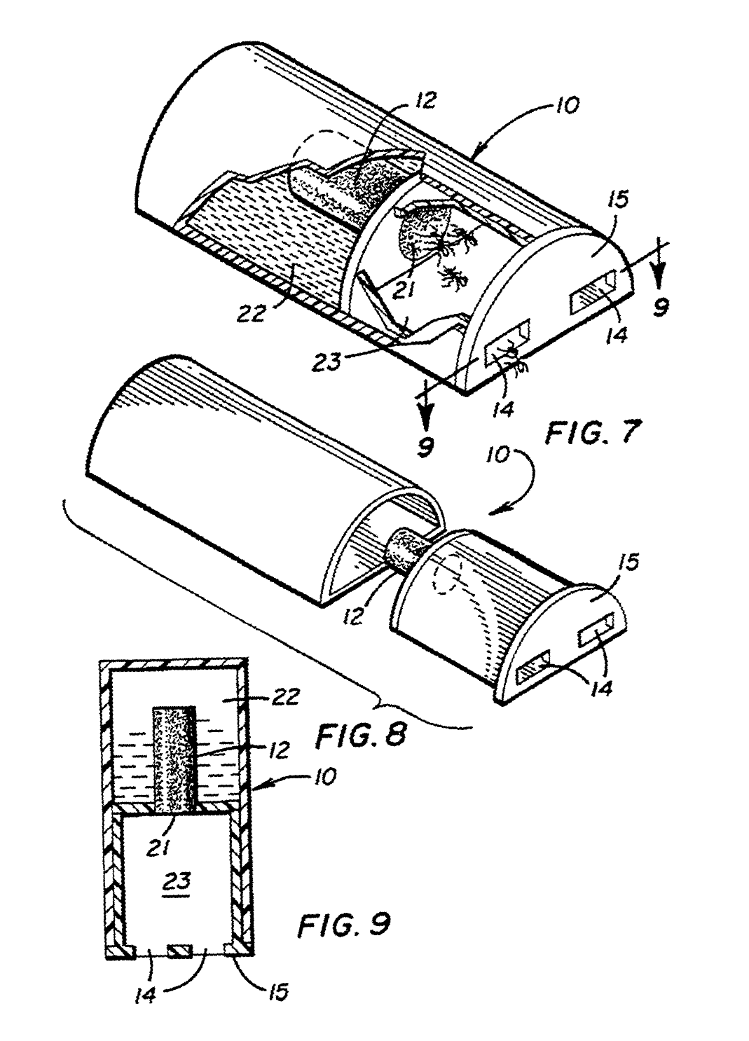

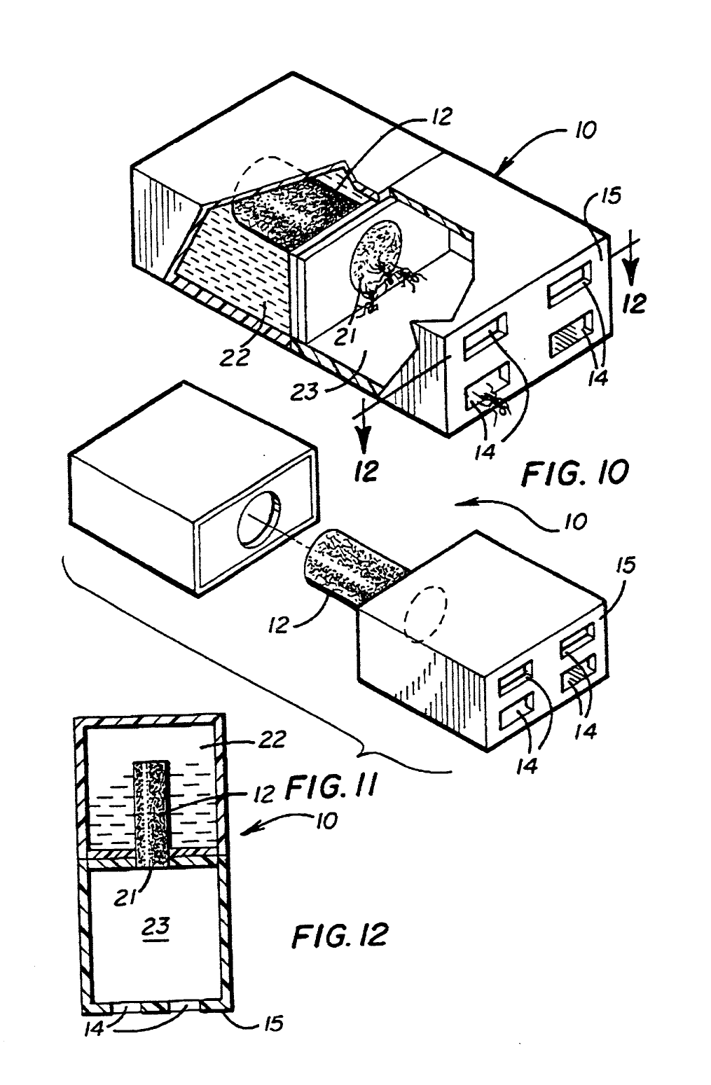

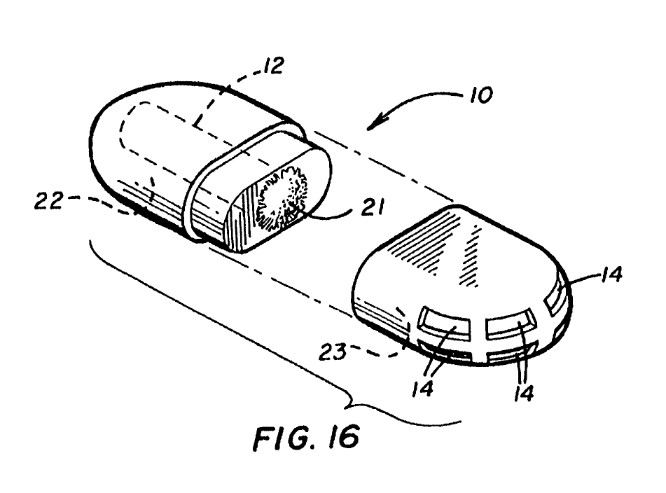

In the preferred embodiment shown in FIGS. 1-16, the wicking material 12 shown generally covers the entire interior end of the cap 13 and is inserted into the base 11 of bait station 10. It is contemplated that the cap 13 will form a liquid tight relation with the interior of the base 11. The reservoir 22 in the bait station base 11 is available to contain liquid insect bait placed there during the manufacture of the insect bait station 10, prior to the assembly of the cap 13 to the base 11. It is preferred that the base 11 includes a substantially uninterrupted sealing means to prevent the liquid insect bait from evaporating or spilling therefrom.

To facilitate transport and storage of the insect bait station with liquid insect bait contained therein, a seal, for example, of plastic removably affixed to the front surface of the cap 15. When in place on the cap front, the seal effectively closes off access to the feeding chamber and the interior feeding surface of the wicking material. An additional or alternative means for preventing leakage or evaporation is to have a plastic film covering the wick material in contact with the liquid insecticide in the base reservoir 22 to prevent the liquid from contacting the wick. Prior to use, the cap could be pushed further into the station and the plastic film ruptured, allowing the liquid to reach the wick material thereby allowing the liquid to wet the interior feeding surface of the wick 21.

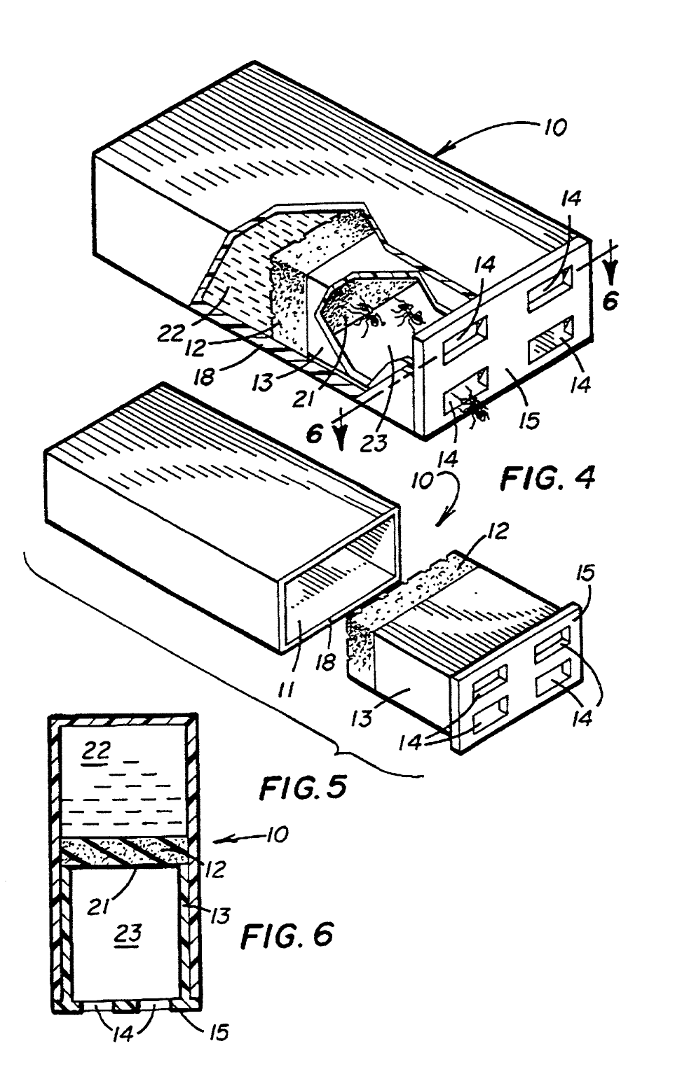

In an alternative embodiment as illustrated in FIGS. 4-6 and 10-16, a substantially rectangular bait station is illustrated. Parts of the embodiment shown in FIGS. 4-6 correspond immediately to the features and parts already described in the embodiment shown in FIGS. 1-3. The embodiment of FIGS. 4-6 includes a cap front 15 with a plurality of access ports 14 through which the targeted insects may reach the wicking material. This embodiment of the insect bait station with the plurality of access ports can be positioned on any surface.

In the embodiment of the insect bait station as shown in FIGS. 1-16, the wicking material 12 is a capillary liquid transport means which include a porous pad or interposed between the liquid reservoir 22 and the hollow body feeding chamber 23 and is securely affixed to the inside terminal portion of the cap 13. Said wicking material 12 having its sides positioned within the station base 11 so that the wicking material substantially fills the bait station base opening, closing the reservoir 22 containing the liquid insect bait within the chamber 22 and restrains the liquid insect bait from flowing out of the bait station. By this means, liquid insect bait contained within the reservoir chamber 22 is restrained from spilling by the sealing means of the cap placed inside the bait station base 11. The wicking material 12 so positioned is in contact with any liquid insect bait contained in the reservoir 22. The liquid insect bait is transported through the wicking material, as through a porous pad by capillary action, to the feeding surface 21 in the feeding chamber 23, were the liquid insect bait is accessible to the targeted insect feeding after entering the feeding chamber through access ports 14 on the cap cover 15. Preferably, the bait station base 11 is placed in a horizontal or longitudinal configuration in an insect environment. This allows the access ports to be readily available for the insects to enter the bait station. At the same time, the liquid insect bait contained in the reservoir 22 is available to transport through the wicking material to the feeding surface 21.

The method of the invention for offering liquid insect bait to a targeted insect includes the step of providing an insect bait station made in accordance with the above description of the insect bait station of the invention and including within the reservoir thereof a selected liquid insect bait. The insect bait station so provided is then placed in a location frequented by targeted insects. Each of the embodiments of the insect bait station described above is suitable for practice of the method of the invention.

The cap and base of all of the embodiments disclosed above of the insect bait station of the invention, together with the feeding structure of the invention disclosed, may be molded or otherwise formed from conventional plastics by conventional means well known to those skilled in the art. The cap and base may be made separately and then joined in liquid-tight relation after the addition of a liquid insect bait, by ultrasonic welding, spin welding, heat sealing, producing a seal by a snap-on fit, or similar, conventional techniques for fabricating plastic objects.

The wick may be formed of any conventional wicking material effective to absorb liquid and effect transport and distribution of the liquid throughout the wick. Suitable materials include fiberglass cloth, textile cloth, cotton or any woven plastics such as nylon, and in any event it is preferable that the wick be flexible. The wick may be secured to the inner surface of wall 6 by, for example, glue or welding.

The wicking material described above may be made of any porous structures otherwise suitable, such as porous woven or non-woven material, porous solids, sponges, and the like. The insect bait stations shown in the drawings are either rectangular or rounded, but the invention should not be limited to the shapes disclosed. Insect bait stations of the invention may be any conventional shape.

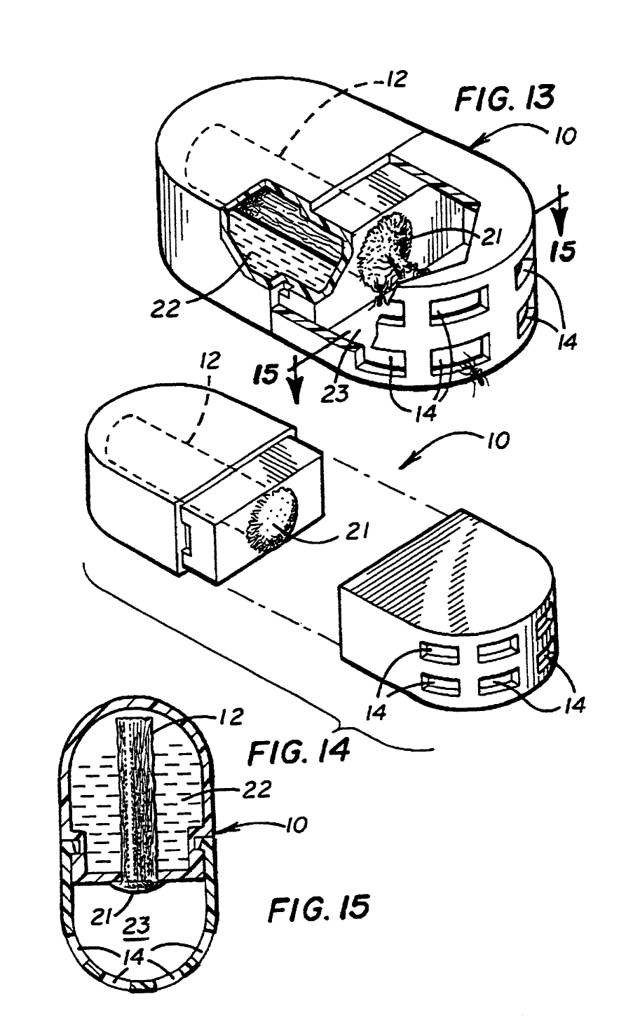

In the preferred embodiment of the insect bait station of the invention shown at FIGS. 13-16, a plurality of access ports 14 are provided which extend through the cap cover front 15 to communicate with the interior of the feeding chamber 23. In this embodiment of the insect bait station the wicking material 12 is a capillary liquid transport means which includes a fiberous wicking material interposed between the liquid reservoir 22 and the hollow body feeding chamber 23. The access ports 14 are of a size such that at least the feeding structure of targeted insects may reach through the access ports and into the feeding chamber 23.

Preferably the wicking material 12 is a inserted into the cap and extends into the liquid reservoir 22 and extends therethrough and provides a feeding surface 21 spaced away and interior from the cap front. This design is preferred since the cap and wicking material arrangement provides insects access to the feeding side of the wick 21 but is spaced away interiorly from the cap cover 15 to prevent children or animals from accessing the feeding portion of the wick through the insect entry ports 14. Preferably, the cap 13 is capable of being pushed inside the bait station to be flush with the front edge 19 and locked therein, so that it cannot be pulled out.

In an alternative embodiment is illustrated in FIGS. 13-16 a rounded end bait station. This bait station has the advantage of not being able to stand upright to block access parts to the interior feeding chamber 23. The rounded end will cause the bait station to fall over and lay in a horizontal position, thereby exposing the entry points 14 to the feeding chamber 23 and feeding surface 21.

FIGS. 1-12 illustrate an end cap 15 which covers the wicking material into the reservoir and is associated with the end cap 15 and feeding chamber 23. Associated with the end cap is a feeding chamber 23 with the wicking material 12 spaced away from the front edge surface of the end cap 15. The end cap contains a plurality of openings 14 on the front edge surface leading into the feeding chamber 23 from the exterior.

FIGS. 13-16 illustrate the embodiment of the bait station of this invention wherein the wicking material is associated with the reservoir and the end cap fitting over the reservoir to help the parts from separating. The end cap and reservoir are joined in a liquid-tight relationship by ultrasonic welding, spin welding, heat sealing, snap-on fit or other similar conventional sealing techniques.

The invention has practical industrial application in the presentation of liquid insect bait to attract insects, which may be done for any of a number of monitoring or control purposes. When control is desired, the liquid insect bait would include an appropriate insecticide. The insect bait station of the invention is useful with crawling insects, such as ants, roaches, earwigs, silverfish, and the like, and would also be useful with flying insects, such as wasps and bees.

While preferred forms of the invention have been shown in the drawings and have been described above, variations will be apparent to those skilled in the art, and the usefulness of the bait station with respect to other insects will also be readily apparent to those skilled in the art. Consequently, the invention should not be construed as limited to the specific forms shown and described. Instead, the invention should be understood in terms of the following claims.

What is claimed is:

1. An insect bait station for administering liquid bait to insects wherein said bait station comprises a base member having an outer wall and floor;
and an end cap secured thereto to form a liquid-tight relation to form a hollow body reservoir;
said end cap having a cap cover, an interior feeding chamber and interior seal and wicking material placed therein;
said cap cover front having entry ports to access the interior feeding chamber and wicking material;
said wicking material is spaced away interiorly from the cap cover front and said wicking material communicates through said end cap with said reservoir to provide liquid feeding surface in the feeding chamber.

2. The insect bait station of claim 1 wherein the wicking material includes a porous pad interposed between said reservoir and the interior feeding chamber where the liquid is transported from the reservoir to the feeding surface in the feeding chamber where the liquid bait is accessible to a targeted insect feeding therein.

3. The insect bait station of claim 1 wherein the cap cover has a plurality of access ports leading to the interior feeding chamber and liquid feeding surface.

4. The insect bait station of claim 1 wherein the end cap is capable of being pushed inside the bait station to have the cap cover front flush with the front edge of the outer wall of the base member and locked therein.

5. The insect bait station of claim 1 wherein said wicking material is a capillary liquid transport means interposed between said reservoir and said feeding chamber positioned within said station base to restrain the liquid bait from flowing out of the bait station.

6. The insect bait station of claim 5 wherein said wicking material substantially fills the bait station base opening thereby restraining the liquid in said reservoir.

7. The insect bait station of claim 1 for administering liquid bait to insects wherein said bait station has an elongated base member and is positioned in a substantially horizontal configuration.
